(19) United States
(12) Patent Application Publication
(10) Pub. No.: US 2007/0136113 A1
(43) Pub. Date: Jun. 14, 2007

(54) Stakeholder interests system and method

(76) Inventor: Eric Cameron Wilson, Sunbury (AU)

Correspondence Address: ETHERTON LAW GROUP, LLC, 5555 E. VAN BUREN STREET, SUITE 100, PHOENIX, AZ, 85008, US

(21) Appl. No.: 10/560,916

(22) PCT Filed: Jun. 16, 2004
(86) PCT No.: PCT/AU04/00807

§ 371 Date: Dec. 15, 2005

(30) Foreign Application Priority Data
Jun. 16, 2003 (AU) 2003903008

(51) Int. Cl. G06F 9/44; G06F 17/50

(52) U.S. Cl. 705/7

(57) ABSTRACT

Stakeholders with an interest in content or digital works create business models which are associated by virtue of their position in a hierarchy. This positioning often corresponds to the structure of collections of content or digital works. When these are requested, business model reconciliation occurs by consulting the relevant sibling, descendant or ascendant business models, taking information from them and resolving conflicts between them to construct composite business models. Also taking into account stand-alone business models covering special cases such as loose content bundles, the resulting composite business models determine content access conditions plus the levying and distribution of fees between the participating stakeholders. The invention has applications in various forms of publishing, ticketing and document-based e-commerce.

This invention relates to a system and method for defining, reconciling and determining interactions between publishers, authors, editors, producers, developers, artists, advertisers, consumers and other content stakeholders, in the context of the content (or other digital work) itself. It also relates to the representation of stakeholder financial interests by reconciling various hierachical and/or stand-alone business models.

In particular, it relates to the combining of business models representing various stakeholder interests and appropriately marking up content to reflect those interests.

### BACKGROUND TO THE INVENTION

The production and consumption of a piece of content, be it destined for online or physical distribution, can sometimes be performed by a single person. However usually, a wide variety of people are involved in producing and consuming works of any usefulness.

Traditionally, coordinating the producers and consumers of content has revolved around four factors: people, time, money and resources. Many software systems reflect this paradigm, representing information with organization charts, timelines, icons, graphs or tables. While these representations have proven useful, they fail to reflect the relationships between publishers, authors, editors, producers, developers, artists, advertisers, consumers and other-content stakeholder interests embodied in the finished product. This means most digital rights management or traditional media management systems are unable to define, reconcile or determine these stakeholder interests in an appropriate manner.

To be specific, a piece of content rarely exists in isolation. A work may belong to a topic, a topic to a subject, a subject to a field, a field to a discipline and a discipline to a library. Moreover, information is often categorized in a number of hierarchical forms—such as grouped by language or title. Overlaid on this are various content stakeholder relationships. For example, a concept creator may receive royalties when any episode in a series is played, while actors may only receive royalties for episodes in which they appear. Again, one reader may have purchased a subscription to view any article on a particular subject in a library, while another has only been given the right to select a particular article for free.

Publishers and advertisers also have their own agendas. Publishers often do deals with one another, such as cross promotional links or special offers to each others' customer base. Such relational deals could be well outside what is traditionally thought of as content, such as bundling free subscriptions to attendees of a particular seminar. Likewise, a special offer could be linked to a person's membership of a club. It might be desirable to provide incentives to frequent users of a site. Or a publisher may offer a volume discount for many subscriptions sold into the one organization.

Advertising deals can also involve a great many factors, such as the number of exposures provided, the length of each exposure and how well qualified the exposed audience is. Advertising deals often contain a mixture of these factors, such as a certain amount of highly targeted exposures sold with a certain number provided at the publisher's or broadcaster's discretion. And a certain percentage of all this activity may be payable to an adverting agency or the creators of an ad.

Efficiently tracking all this is difficult enough, yet online advertising is notoriously inadequate for sustaining commercial online publishing anyway. This is because traditional media, which has pioneered the concept of advertising over many years, is inherently different from its online cousin. Typically, when a person looks for content online, they go to a search engine or directly to it using a hyperlink. On that page they may find one advertisement. However to go to an article in a magazine or newspaper, half a dozen ads might be sighted. Likewise, TV and radio keep pumping out ads for the duration of the show or until switched off.

This means traditional media advertising exposures are not sold by the glass as they are online, but by the barrel—by virtue of circulation or ratings. A TV show or newspaper is therefore a content package, each containing multiple advertising exposures. A Web page is not, just being a single directly accessible piece of content that must win single exposures solely on its own merit.

Some Web sites have tried to compensate for this using pop-up windows containing additional advertising. However consumer reaction has been negative, many employing pop-up blocking software. Another ploy has been to include the first paragraph of the article with a big ad next to it, with a link at the end taking the reader to the full story which contains another ad. These schemes are seen as time-wasting intrusions, sparking resentment in the consumer not interest in the advertiser.

Therefore a method of online content bundling is needed to increase the advertising exposures for each piece of content in the requested bundle. Until this happens, by its very nature, online advertising cannot be anywhere near as lucrative as its traditional media rivals.

It's a sobering thought to consider that all the types of interactions described thus far might be desirablely triggered as a user clicks a single hyperlink. For in the sometimes fickle content business, being commercially agile to make multiple custom deals is key to survival. Unfortunately, both traditional and digital media management systems, being so based on people, time, money and resource concepts, don't effectively represent all these enduring relationships embodied in finished content.

What is needed is a system which can define various content stakeholder interests, then reconcile and combine them for automatic financial intermediation between all the interested parties—not just a few.

The lack of such a system has restricted the commercial online publishing industry to traditional publishing models. The promise of e-commerce was just-in-time supply chain management. But because all stakeholders have not been linked into a central system via custom business models, online publishers cannot easily calculate how much each party should receive from the proceeds of each sale. This lack of timely management information means digital publishers have to commission new works in much the same way as their forebears. They must commit to pay content creators in advance of any sale being made, placing financial constraints on content which might be otherwise be created.

Therefore, future prosperity of the as-yet unproven commercial online publishing world, could depend on content creators somehow finding a way to share more of the risks and rewards, relieving publishers of bearing this burden alone. But if an efficient revenue splitting mechanism can be found to defer upfront costs to the point of sale, more content could be created as risk is amortized across more stakeholders.

Risks could also be better distributed between content consumers. As things stand, people who have just paid for a purchase by credit card are treated the same as those paying from an account whose credit card transactions have been settled. Yet clearly, the latter's funds are much less likely to be subsequently dishonored. What is needed here is the ability to apply different business models to transactions involving cleared funds and those still pending, or those with good payment histories and those who are unknown.

Because all of these content-based relationships are not factored into a single system which maintains commercial flexibility by recognizing different stakeholder business interests, sometimes publishers are not aware they are loosing money before it's too late. When this happens, its often the content consumers who suffer, missing out on the new material they already paid for.

But financial transactions are not the only relationships embedded within content. An author may wish to allow summary or contact details to be easily copied by readers, while protecting the rest of the document. An advertiser may not countenance their image or length of exposure being reduced beyond a certain minimum size. An editor of a picture book or news-pictorial may desire fitting the text around pictures, while for others, optimizing text readability is the most important thing. Yet shouldn't the content consumers be allowed to override them all, particularly in a case where they have paid extra to do so?

If a system capable of solving these problems existed, a new kind of document-based e-commerce could flourish. If content were controlled in relation to its location within a hierarchy—with subsequent copying and distribution also controlled—documents could contextually confer title to goods, services or property upon various stakeholders.

In all cases, different content owners may have different access terms and conditions, for different geographical regions. All this means a multitude of scenarios is possible. This is why the commercial online publishing industry desperately needs a system which overlays multiple business models atop various contextual content hierarchies and other organizational schemes.

### OBJECT OF THE INVENTION

It is an object of the invention to define, reconcile and determine interactions between content stakeholders according to business models reflecting their interests, in relation to the content's context.

It is a further object to use stakeholder business models to increase the potential for online advertising revenues through the loose bundling of content, plus automate the collection and distribution of fees, amortizing content creator risks and rewards to spur development.

It is a further object to use stakeholder business models to predict possible stakeholder profits or losses in relation to content being offered.

Further objects will be evident from the following description.

### DISCLOSURE OF THE INVENTION

In one form, although it need not be the only or indeed the broadest form, the invention resides in a stakeholder system, which defines, reconciles and determines content stakeholder interests, comprising:
one or more business model builders, that allow publishers, authors, editors, producers, developers, artists, advertisers, consumers and others to create and associate business models and mark-up with content;
one or more business model reconciliation engines for checking business models associated with content to determine one or more of viewing conditions, or to determine the levying of fees or distribution of fees.

Preferably, the invention also comprises one or more reporting engines, to predict financial or other outcomes of a defined set of business models; one or more processed content repositories or caches; one or more original content repositories, one or more master business model repositories or caches, one or more content mark-up and staging applications—with various mark-ups being optionally chargeable to stakeholders, and one or more locational content control units.

Business models are used to implement relationships between all the stakeholders, including end-users. They comprise but are not limited to scripts, documents and data. They may be digitally signed to ensure their authenticity or confidentiality. Business models can also be used as digital routing slips between stakeholders, making sure content has passed though qualified hands before being approved for publication.

Stakeholder systems, are suitably distributed across computers convenient to stakeholders and are in communication with one or more management systems. Preferably, a stakeholder system will include or have access to an original document repository, containing original copies of content to be made available for publication. These may contain, text, graphics, videos or animations, scrips, embedded applications, advertising, links or other information.

The system's business model builders provide each stakeholder with the ability to associate relevant business models with content, or the containers in which content is stored (such as file system folders), or to create stand-alone business models. Stand-alone business models may be applied to content to override other business models which would otherwise be associated, either expressly by the stakeholder or automatically via a model associated with the content's container. In this way, stand-alone business models can be used to create special deals.

One way to distinguish when a stand-alone business model is to be used over the other types is when its name is appended to a particular URL as a parameter. This method has the advantage of allowing regular references to the content to continue, invoking the usual terms in the regular business models. So multiple stand-alone business models can be associated with the same content simply by appending different parameters. A plurality of content can be referenced in a business model, to create loosely bundled content.

Stakeholder systems also contain reporting engines, allowing for example, publishers to predict their potential profit or loss on a particular item of content. Another example allows advertisers to correlate exposure times, frequencies and locations to anonymous user click-throughs or users who are prepared to provide additional identity details.

Additionally, stakeholder systems also so support specialised content mark-up to moderate XML, Screen Paginating or other display systems, which might otherwise independently regulate the use or appearance of content. The invention may have particular application to our co-pending application entitled “Document Display System and Method”, which is incorporated herein by reference.

After business models have been associated or appropriate mark-up has been applied, content is stored in a processed content repository. Content without specific business model associations can also be stored, because business models can be inherited from content containers. Business models are stored in a secure business model repository, approximately corresponding in structure to the processed content repository; Although on low security systems, the same repository could be used for both business models or content.

These repositories are staging areas where information is held in readiness for transfer to one or more end-user display or management systems respectively. Suitably, this information might also be passed or be made available to one or more stakeholder systems, containing or interfacing their own business model reconciliation module, for further processing. In this way, a workflow or approvals process can be implemented.

Management systems, containing or interfacing a business model reconciliation module, may be located on centralised servers, across a number of server groups, on end-user machines or between a combination of these. The invention may have particular application to our co-pending application entitled “A System for Secure Distribution of Electronic Content and Collection of Fees”, which is incorporated herein by reference.

When a user requests content or a reporting engine is engaged, a business model reconciliation engine will look in the repository for all the business models that could apply to the situation. The location of these business models is used to provide prioritisation in the case of conflicting instructions. By assembling all the business models together using this method, the reconciliation engine determines one or more of viewing conditions, levying of fees and distribution of fees. By this method, stakeholders can be paid or charged according to the value or volume of their content as it is released.

Parts of the stakeholder system, such as the business model reconciliation engine, may also reside embedded within or alongside other content systems. Good examples of these are digital rights management systems or catalogue systems (server, desktop or device), where business models, content metadata or the content itself might be cached close by. In this case, the reconciliation engine could be used to provide content usage information to these systems directly.

### BRIEF DESCRIPTION OF THE DRAWINGS

To assist in understanding the invention, some preferred embodiments will be described with reference to the following figures in which:

FIG. 1 shows an overview of a stakeholder system;

FIG. 2 shows the types of transactions a business model might represent;

FIG. 3 illustrates the increased advertising display opportunities of loosely bundled content;

FIG. 4 shows the three major types of business models offered for the pricing of content, the third option being described in FIG. 3;

FIG. 5 shows the four main types of content pricing schemes, whose scope is determined as per FIG. 4;

FIG. 6 shows business model pricing options when ‘Fixed Price’ is selected as in FIG. 5

FIG. 7 shows revenue splits to various stakeholders a publisher might approve;

FIG. 8 is a flowchart of one of the system's business model reconciliation routines, for prioritising and combining multiple business models;

FIG. 9 is a flowchart of one of the system's reporting engines (profit & loss calculation), as accessed through FIG. 7, which calls the routine in FIG. 8.

FIG. 10 is an example of a stand-alone business model which associates loosely bundled content.

### DETAILED DESCRIPTION OF THE DRAWINGS

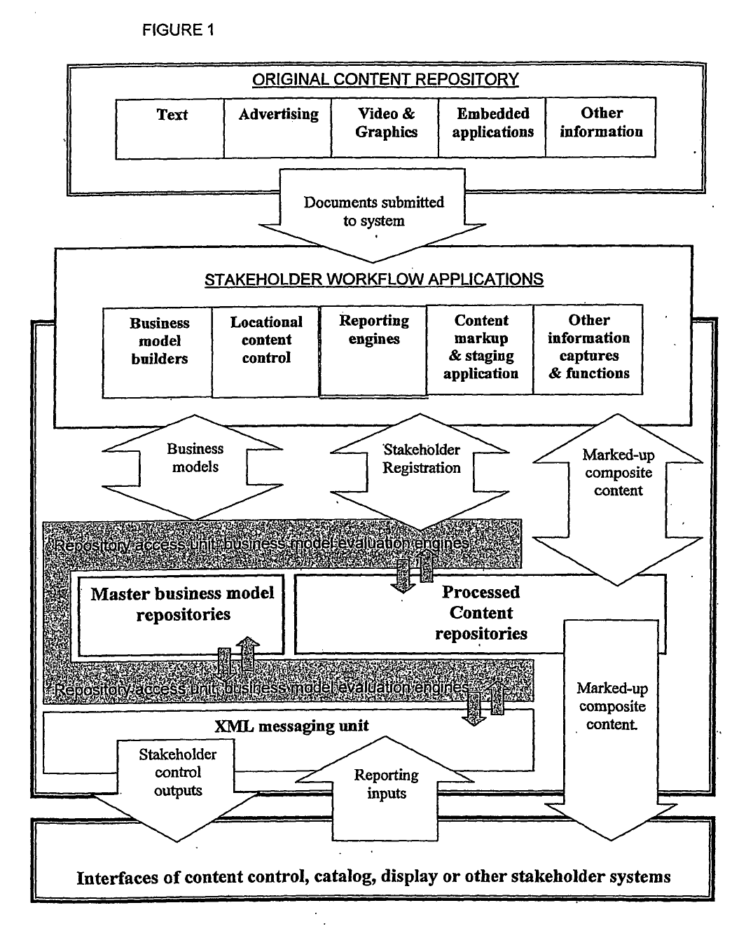

Referring to FIG. 1, there is shown a schematic of a stakeholder system in an application context. Stakeholder systems provide management functions for authors, publishers, advertisers advertising executives, editors, developers, the invention's operators or any other party with an interest in content. They comprise a set of workflow applications linked to content and meta information repositories. These may be linked via virtual private networks and an XML messaging unit to display, management or other stakeholder systems. In the preferred embodiment of this invention these repositories are comprised of file system hierarchies, although they well could be other stores such as relational databases.

The stakeholder workflow applications comprise of:
1. Business model builders: These associate information such as Title, Author, Summary and Business Model indicators to content. By noting these indicators, the business model reconciliation engine is able to determine the way content should be treated, by consulting the business models to which the indicators refer. Alternately, the system can allocate default business models to content, derived those associated with its containers, such as the file system folders above it.
2. Business model builders create a marketing structure around a collection of content through associations with business models. A business model will typically contain pricing information to which content refer via their indicators (which could be as simple as reusing the content's own filename with a different extension), as well as revenue and expense splitting ratios between stakeholders. A special kind of business model is an advertising model, embodying the terms and conditions of embedded content for automated billing and display.
3. Advertising models (as a type of business model) allow advertising executives and creative staff to associate objects embedded within content to an advertising model. An example of an advertising model could be to display a set of advertisements in random order as a page is accessed or change the advertisements if a user revisits a page, with the appropriate fees for each type of exposure. Another may dictate that advertisers are charged according to the number of seconds their content remains displayed on a screen.
4. Content markup and staging: These applications can be used to govern the release of content and meta information from the system's processed content and business model repositories to presentation. Web interface and management systems as well as other stakeholder systems. This allows publishers to perform functions such as setting ‘opening dates’ on new parts of their site, managing the content update process or rolling back their sites to previous versions of content.

Authors may also mark up summary or contact details for copying to the user's clipboard, printing on their printer or saving to their hard drive. This can be used to override a display system which would otherwise protect these portions of content. An editor of a news-pictorial or picture books may desire fitting the text around the pictures (perhaps by specifying a minimum size beyond which reduction to fit is not permitted), while for others, optimizing text readability is the most important thing. An advertiser may not countenance their image or length of exposure being reduced beyond a certain minimum size, or at all. The way such content should be treated can be marked up within the content.

Information within business models may be associated with specific elements within a content package, such as a page containing pictures or a group of pages either packaged or marketed together, by placing corresponding tags within the content or its containers, or by referring to navigation points intrinsic to the content itself. These could include character, paragraph or line numbers, document structures such as headings and sub headings, bookmarks phrases within text, and the like. In this case, business model reconciliation might take place with some variables in the process being extracted from the content as required.
5. Other information captures and functions: A number of other functions complete the stakeholder application suite. This includes reporting tools allowing all the stakeholders to review the progress of their interest in sites and content

It is possible for a content consumer to be entitled to several offers as represented by business models at one time. For example, she may be both eligible for a corporate discount as well as a discount for having attended a seminar as part of a marketing campaign. When this happens, by default, the system will determine the cheapest option for the end-user or advertiser or offer them a choice of under which set of terms and conditions the document is to be made available. A publisher may also specify that some or all discounts should be additive, although this increases the chances of making a loss from the activity.

The content catalog and the content itself can be restricted or released for viewing, via connecting catalogue and content control systems; according to who is trying to access it For example, this could be implemented via a business model which specified only users who have already viewed one piece of content will be allowed to view another. If the first piece was a ticket to a seminar, then the system may allow the owner of the ticket access to video files of the seminar. In this way, the stakeholder system can be used for document-based e-commerce, where buying one piece of content may also constitute title to another or perhaps some good, service or property. This is especially so where controlling content (being the bearer of it by virtue of its placement in a person's folder for example, with business models governing how such title-content might be disposed) grants such title to one or more stakeholders. Again, this may have particular application to our co-pending application entitled “A System for Secure Distribution of Electronic Content and Collection of Fees”.

Different content owners may have different access terms and conditions for different geographical regions. These might also be specified in a business model, for display in a contract screen soliciting a user's consent. By combining geographically targeted contract screens (which themselves are a form of content) with geographically targeted content, publishers can minimize the risk of infringing laws in the content consumer's locale.

One way this can be achieved is to have business models specify different content hierarchies according to the IP address of the incoming request. Another option is to use locational information from a device, such as a cell phone or GPS unit. This level of locational granularity could b used for publishing content such as tour guides or directions to specific objects.

Business models can also be used to localize content by automatically applying currency conversions. The stakeholder system can be used to restrict or substitute the content catalog supplied to a Web server or other interface according to geographical regions. It can also be used to create business models that restrict access or re-price content according to geography.

Business models, which at all times may also include end-user preferences, could also explicitly specify the language of the content presented (including computer languages), perhaps overriding settings generated by the system's locational content control.

User preferences in business models could also influence the way content is marked up for display. For example, a user could specify greater magnification of the content to suit their eyesight. In this case, the onus is on the display system (or perhaps a related content control mechanism) to check a business model cache or the invention's master business model repository for such end-user preferences. The system may also be used to levy fees for different mark-ups, such as those requiring extra processing by a service provider or other intermediary to complete.

And a user may request a specific business model be applied in their particular case, such as when responding to a special offer. Such an offer may be issued publicly or to an individual based upon a group or contextual circumstance. A contextual circumstance might include a combination of factors, such as if the user belongs to a particular group and has previously viewed or purchased certain content.

Such a stand-alone business model, not necessarily included within in a hierarchy of business models, could be invoked both explicitly or by implication. Explicit invocation includes embedding references to a custom business model inside a user request such as within a linking URL, or by the user quoting an offer name or number or business model path. Business model invocation by implication might be based on factors such as the source of a request, for example where particular pages on a site describe different offers. Stand-alone business models may also be organized in a custom hierarchy to be subject to a reconciliation process independent of content organization.

Business models can be used to apply different fee structures to transactions involving cleared funds and those still pending, or those with good payment histories and those who are unknown. Incentives can also be given for transactions posing lesser risks.

Business models may contain references to other business models, which optionally might reside in an unrelated hierarchy or branch of a hierarchy. In this case, more than one reconciliation process could be triggered to make an appropriate determination.

To model complex relationships between stakeholders, such references within a business model to other business models, could themselves be structured hierarchally, so as to create master and slave reconciliation processes, which themselves might also involve hierarchical information processing and so on.

References within business models to other business models, are useful where separate sets of relationships are to be reconciled together, such as determining price or revenue splits in a content package, whose elements represent separate teams of stakeholders. For example, access to online games may be bundled with pop concert tickets, as a pure marketing deal, with no relationship between the two sets of content developers. In this case, a master business model might be maintained by a promoter to compensate promotion stakeholder activities, plus references to the business models representing each group of stakeholders from which the content was derived. Stand-alone business models may also work in conjuntion with those associated with a content hierarchy in the usual way. This makes them easier to maintain, because they only have to contain detail which differs from that found in the content hierarchy scheme. Stand-alone business models may also be implemented for reconciliation in a hierarchical manner, independent of content placement.

The system's processed content repositories are where content is stored and released, optionally under the supervision of an external content control system, to various information display systems, often via virtual private networks. They also form the staging area for future content releases plus an archive of past releases which have been withdrawn from circulation.

An XML messaging unit is provided to facilitate information transfers between stakeholder systems and other systems.

A preferred embodiment of these systems could be used in the following scenario:
1. A publisher nominates an application service provider or elects to run a stakeholder application suite on their own systems;
2. The publisher registers the stakeholders to be recognized by the site;
3. Authors use the stakeholder application suite to stake their claim on a content via content indicators;
4. A publisher submits content and approves business models to the master repositories, in so doing acknowledging the claims made by the author indicators;
5. Business model indicators are associated, recognizing the role of advertisers, editors, advertising executives, developers and others;
6. At any stage, content may be marked up for manual optimization for image display using remote display protocols. For example, it might be necessary to stop image resizing at a point where a picture's detail can still be properly seen, such as with a map;
7. At any stage, content and its organization within the repository may be marked up to control the timing of their release;
8. Information about content generated in stakeholder systems is retrieved from the various repositories via XML Messaging engines by the content control and catalog systems;
9. Application service providers running interface systems also access repositories to display information in Web, WAP or pages described by other protocols or formats, with information generated by a stakeholder system;
10. As requested by the user and allowed by a content control system, copies of documents are released from the system's processed content repository to various presentation systems;
11. Reports are provided to stakeholder applications from other systems, for real-time management of content, sites, distribution of content to ASPs and other stakeholder relationships;
12. All of the above functions are also designed to maintain their currency on an ongoing basis. For example, a document's author revenue shares may change over time as a document is updated by different people.

The stakeholder system is designed to support rich collaboration between all the participants. Therefore stakeholder systems may be distributed across a large number of locations.

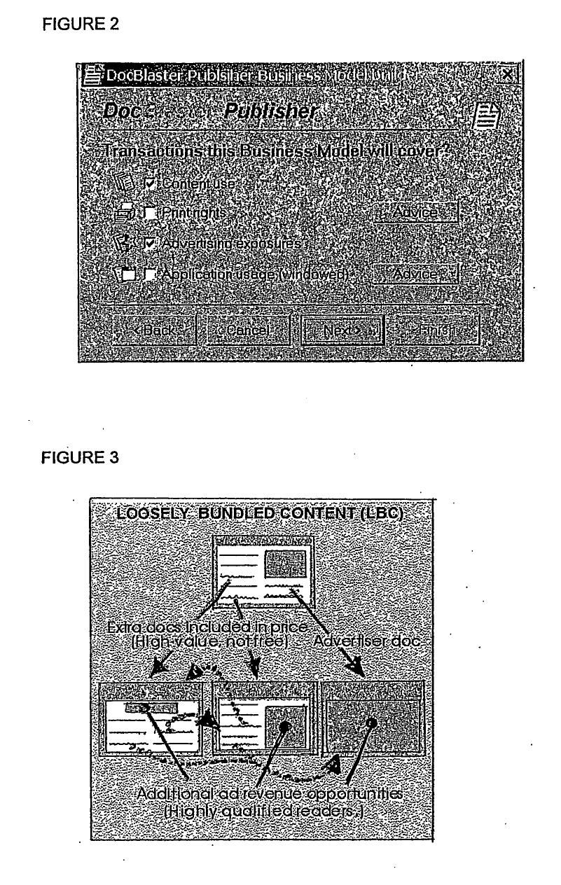

FIG. 2 shows some of the types of transactions a standard business model can represent In this implementation, content use covers pricing, document availability, locational substitution, currency and other end-user informational matters.

Print rights determine if and how often the user is allowed to print out content, for use with a content control system. For example, in order to over come some of the difficulties of printing over the Internet, the system may allow users a few test prints. Then when, satisfied, the publisher may set the business model to allow a certain number of copies in the price. On the other hand, the business model may be set to charge for each attempt regardless of the outcome. Or the publisher may set the business model to allow a combination of test, pre-paid and pay-per-print attempts. Where the content is located on an end-user's machine, less liberal print rights may be enforced by a local content control system, in which case the business model could be adjusted accordingly. The system also supports the marking up of print rights, obliging intelligent display systems to protect some parts of the content-while allowing unfettered printing of others.

An advertising business models can also be selected, but this previously discussed specialized case would uncheck the other options.

Windowed application usage, such as a custom application launched by clicking on a hyperlink, can be charged by time or by the CPU cycles it consumes. Embedded applications (macros or applets) are usually included as part of the content's price.

FIG. 3 illustrates the increased advertising display opportunities of a ‘loosely bundled content’ implementation. This is created when a business model specifies rights to more than one document. Typically, content consumers are allocated a certain amount of time and/or accesses with each document or are given a total amount of time and accesses between all documents, which is recorded against the first one of the group entered. (The idea supported is having already paid for a taste, content consumers may be tempted to look at another screen page or two, increasing the number of targeted ad exposures.) Loosely bundled content is also good where a publisher wishes to fully use a minimum payment instead of allowing consumers to have loose change in their accounts.

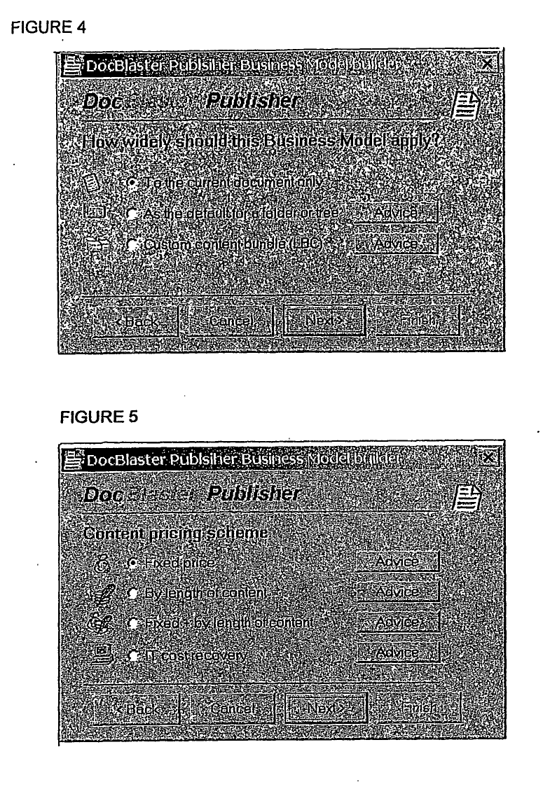

FIG. 4 shows the three important types of business models offered for the pricing of content, the third option being described in FIG. 3. In this implementation, the term ‘Custom Content Bundle’ refers to a stand-alone business model with rights to more than one document specified.

FIG. 5 shows the four important types of content pricing schemes, whose scope is determined as per FIG. 4. IT cost recovery mode is good for where the content is to be given away, but the organization does not wish to bear the costs of doing so.

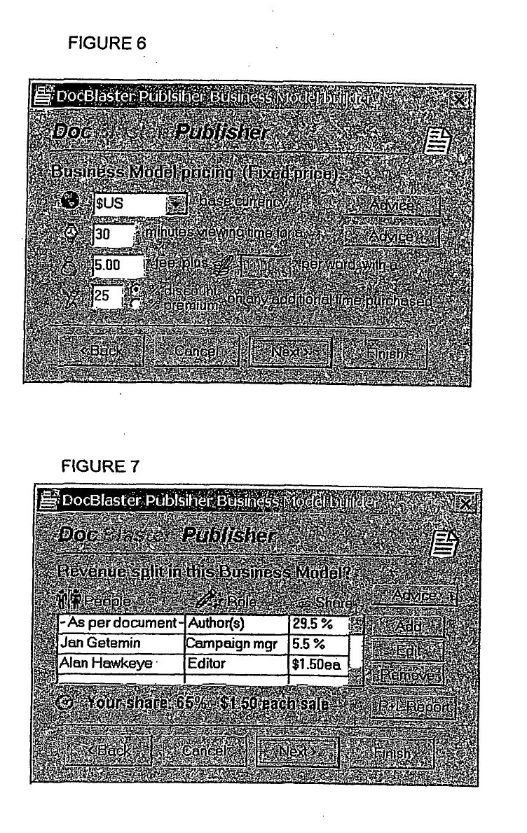

FIG. 6 shows some business model pricing options when ‘Fixed Price’ is selected as in FIG. 5. FIG. 7 shows a basic implementation of revenue splits to various stakeholders that a publisher might approve. The system accepts splits as percentages of revenues or in absolute values. Where no values are specified, the system will use default values derived from the content (such as a word count or author) or content containers (where ascendant or descendent business models are associated with them). For example, author payments may be a fixed percentage negotiated when a document was submitted. If so, this could be carried through into the revenue split as a minimum fee regardless of how any other payments are allocated. Therefore it will not always be possible to see immediately whether content is profitable or not, until the appropriate report engine is run to collate the effects of all the business models involved.

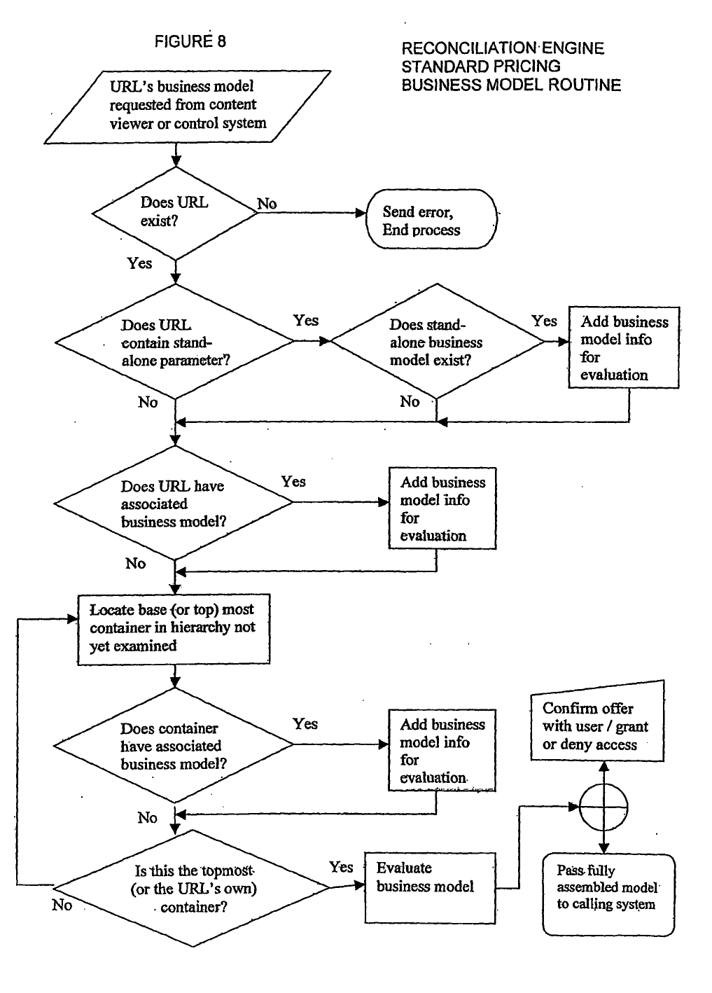

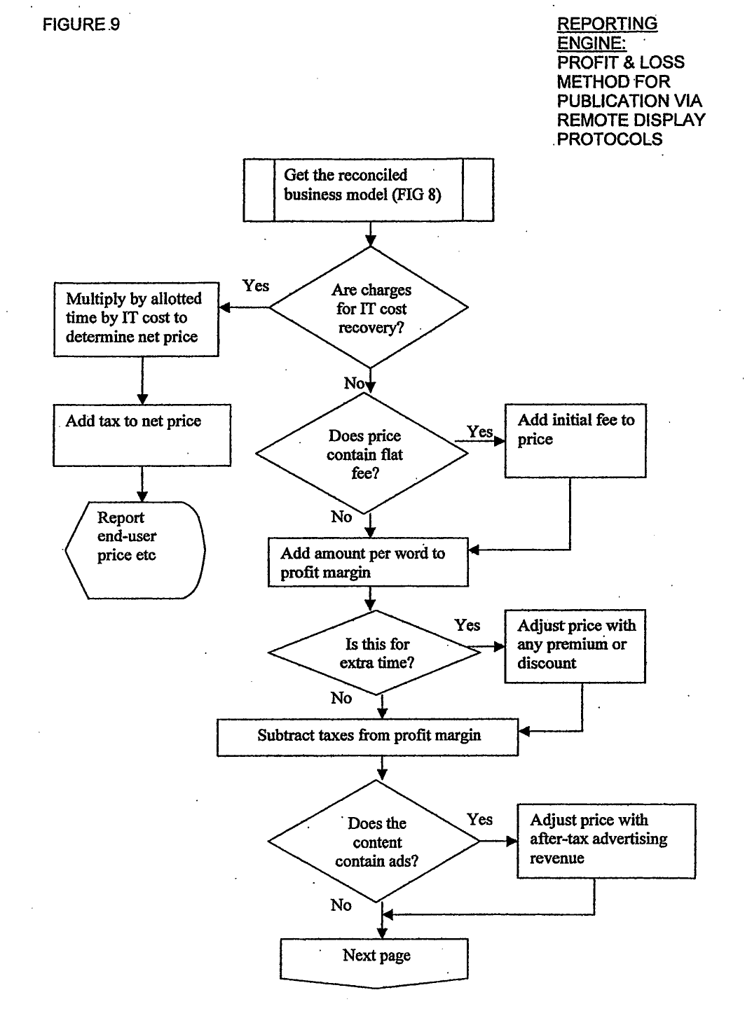

FIG. 8 is a flowchart of one of the system's business model reconciliation routines, for prioritizing and combining multiple standard pricing business models. This embodiment of the invention utilizes the following steps:
1. A request is made for a composite business model embodying pricing and revenue splits and the financial information pertaining to a universal resource locator or some other content identity token (herein known as a ‘URL’);
2. The existence of the URL is checked, the process terminates with an error message if not found;
3. The supplied URL is parsed to see if it contains one or more stand-alone business model parameters;
   a. If one or more stand-alone models are specified, their contents are added to the composite business model;
   b. If there is a clash of information, the system may suitably determine an acceptable outcome by employing any combination of:
      i. The information's date;
      ii. An evaluation of the information's source;
      iii. A specified priority level;
      iv. The order in which the information was received;
      v. An evaluation of the information itself;
      vi. The location from where the information came;
      vii. According to scripts, including within the business model, or other specified criteria;
4. If the URL has a business model associated directly to it:
   a: Information of a type not already included may be added to the composite business model being assembled;
   b. Information of a type already included is ignored in relation to the composite business model being assembled;
5. Cycle through the related content containers in which the content resides, from the more specific (the folder in which the content appears for example) to the more general (the topmost folder in a file system for example:
   a. If a standard pricing business model is associated with the container
      i. Information of a type not already included may be added to the composite business model being assembled;
      ii. Information of a type already included is ignored in relation to the composite business model being assembled;
      iii. Information of a type already included may be overwritten into the composite business model being assembled, unless the type has been designated as priority information.
   b. Where a super business model is created to override all others, the process of (a) is reversed.
6. Optionally evaluate the composite business model by performing calculations or executing scripts which may be part of the composite business model;
   a. Optionally, if no author or other necessary information has been specified in the business model, check the content itself for the required information;
   b. Optionally, if any information has been obtained from the content itself as in step (a), automatically add the information to the content's directly associated standard pricing business model, creating one if not existing already;
7. Optionally pass the now fully reconciled business model, or parts of it, to the process calling the method, such as a content control or catalog system;
8. Optionally present information in the reconciled business model, which in this case may from an offer to an end user or other stakeholder, to the process calling the method, such as a content control or catalog system;
9. Optionally from a determination made by the evaluation in step 6, communicate any content access or other rights to the process calling the method, such as a content control or catalog system.

Of course steps in other business model reconciliation engines may vary significantly, depending on what stakeholder interests the business models being evaluated represent.

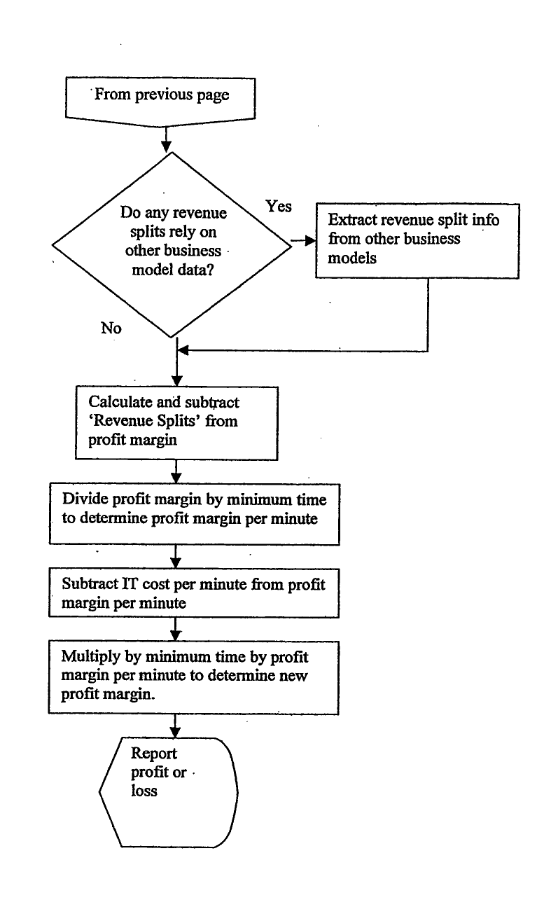

The ability to reconcile business models allows the invention's reporting engines to predict possible financial or other outcomes. FIG. 9 is a flowchart of one of the system's reporting engines (profit & loss calculation for publication via remote display protocols), as accessed through FIG. 7, which calls the routine in FIG. 8. The method consists of the following steps:
1. Get a reconciled standard price business model for the URL
2. If the basis of the levying of fees to a content consumer is cost recovery:
   a. Multiply the allotted minimum time given to the content by the cost per minute of display within remote display protocol publishing system to give the net price;
   b. Add any taxes to the net price to give the total price
   c. Report the net price, tax, total price, and profit margin as zero
3. If the basis of the levying of fees to a content consumer is not cost recovery:
   a. If the price contains a flat fee for initial content access, add it to the profit margin
   b. Add any specified per-word cost to the profit margin
   c. If the report is to calculate the profitability of additional time or content accesses sold:
      i. If a minimum time has been specified for the additional time charges, use it as the minimum time given to the content
      ii. If a rate has been specified for additional time or access charges, use it to recalculate the profit margin
      iii. If no rate has been supplied for additional time or access charges, adjust the profit margin by the percentage discount or premium specified
   d. Record the profit margin as the content consumer's price
   e. Where applicable, subtract tax from the profit margin
   f. If the content contains advertising, initiate an advertising revenue report and add after-tax advertising revenue to the profit margin
   g. If any revenue splits rely on data from other business models, initiate an appropriate business model engine to obtain the required information
   h. Calculate and subtract revenue splits from profit margin
   i. Divide profit margin by the minimum time to determine profit margin per minute
   j. Subtract IT cost per minute from profit margin per minute
   k. Multiply profit margin per minute to determine the new profit margin
   l. Generate a profit and loss report containing content consumer price, revenue splits, tax, IT cost and profit margin figures

It will be appreciated steps involving taxes may vary according to the legal jurisdiction in which the system is operating. Steps in other report engines may also vary significantly, depending on the business models being analysed.

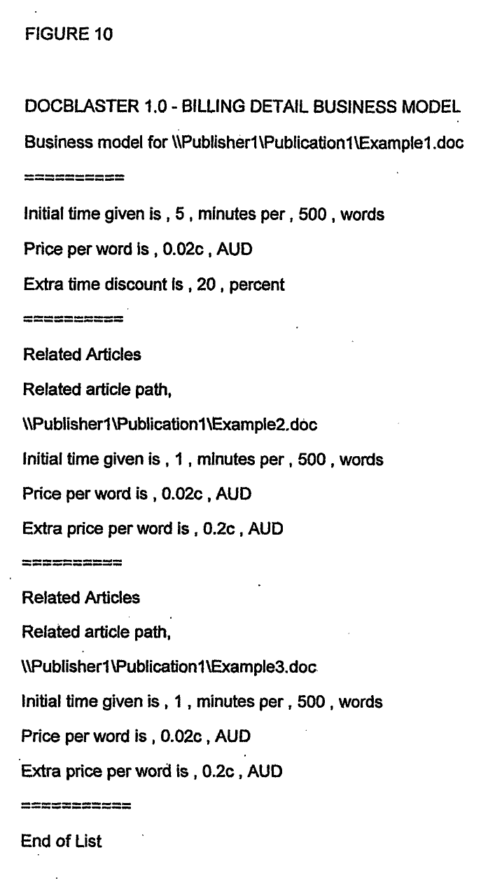

FIG. 10 is an example of a stand-alone business model which in this case associates loosely bundled content. In a preferred embodiment, business models are recorded in XML format However for clarity, FIG. 10 is expressed in comma-delimited English. Binary formats are also possible.

In this example, the minimum time allowed is based on the length of the content itself. This allows the price to adjust automatically as changes to a document are made, such as the addition of more information. Video information could be priced the same way, using running times or file sizes as the basis of calculation.

The loose bundling is created by the inclusion of related articles in the business model. In this example, only a fifth of the regular time is supplied to related content, but it's made available at 1/10 of the cost. If the content consumer wishes to purchase more, they can do so at the same rate as the first document.

FIG. 10 does not include information pertaining to revenue splits between stakeholders. These could include payment to a referring site which promoted the content, payment to embedded application developers who helped produce the content or Application Service Providers hosting the content—among others. These obligations and entitlements, as expressed in business models associated with the content itself or its containers, are able to be included through the operation of a business model evaluation engines.

In this way, the invention allows for business deals to be associated stakeholders and content independently, while providing an efficient means of reconciling their interests. No other system has the same flexibility and ease of management for defining, reconciling and determining interactions between content and all its stakeholders.

The term ‘content’ in this specification may refer to both digital and physical works. Throughout the specification, the aim has been to describe embodiments of the invention without limiting the invention to any specific combination of alternate features.

1. A system for defining, reconciling and determining interactions between content stakeholders or stakeholders in digital works comprising:
Stakeholder systems which associate business models with content or digital works or their hierachical repositories;
business model reconciliation engines for finding and checking said business models, suitably combining and evaluating said applicable business models into composite business models, for determining the levying of fees or distribution of fees.

2. The system of claim 1 with one or more reporting engines predicting financial or other outcomes of a defined set of business models.

3. The system of claim 1 where one or more stand-alone business models are also evaluated by a reconciliation engine.

4. The system of claim 1 where business model reconciliation engines also support loosely bundled content.

5. The system of claim 3 where one or more stand-alone business models are explicitly invoked-when appended to a particular URL

6. The system of claim 3 where one or more stand-alone business models are invoked by implication, according to which page a request for content or digital works is received.

7. The system of claim 3 where business models contain references to other business models residing In an unrelated hierarchy or branch of a hierarchy.

8. The system of claim 7 where more than one reconciliation engine is triggered to make an appropriate determination.

9. The system of claim 1 where stakeholder systems mark up content to associate those interests with business models.

10. The system of claim 1 where content or content containers are examined to determine stakeholder interests.

11. The system of claim 1 where stakeholder systems associate business models with specific elements within content or a digital work.

12. The system of claim 1 where business models apply different fee structures to transactions involving cleared funds and those still pending, or those with good payment histories and those who are unknown, or incentives for transactions posing lesser risks.

13. The system of claim 1 where the content grants title to goods, services or property.

14. The system of claim 13 where the-granting of title is to one or more stakeholders.

15. The method of reconciling business models including the steps of:
Receiving a request for a business model by specifying one or more desired content accesses;
Finding the related one or more business models to the request located in one or more hierarchies;
Combining information from the business models to create composite business models.
Sending the composite business model to the calling process for the levying of fees or distribution of fees.

16. The method of claim 15 where one or more stand-alone business models are specified for inclusion in the composite business model.
